(19) United States
(12) Patent Application Publication
(10) Pub. No.: US 2009/0081537 A1
(43) Pub. Date: Mar. 26, 2009

(54) BATTERY PACK CASE, BATTERY PACK INCLUDING THE SAME, AND METHODS OF MANUFACTURING THE BATTERY PACK CASE AND THE BATTERY PACK

(76) Inventor: Il-Joong Kim, Suwon-si (KR)

Correspondence Address: CHRISTIE, PARKER & HALE, LLP, PO BOX 7068, PASADENA, CA, 91109-7068, US

(21) Appl. No.: 12/176,970

(22) Filed: Jul. 21, 2008

(30) Foreign Application Priority Data
Sep. 21, 2007 (KR) 10-2007-0096422

(51) Int. Cl. H01M 2/02; B29C 45/00

(52) U.S. Cl. 429/176; 264/299; 429/7; 29/623.1

(57) ABSTRACT

A battery pack case which is formed by injection molding, the battery pack case including: a surface having a hole for removing a flow mark on the surface of the battery pack case corresponding to a gate region of a metal mold, wherein the flow mark is removed by the hole.

### CROSS-REFERENCE TO RELATED APPLICATION

This application claims priority to and the benefit of Korean Patent Application No. 10-2007-0096422, filed Sep. 21, 2007, the entire content of which is incorporated herein by reference.

### BACKGROUND OF THE INVENTION

1. Field of the Invention

The present invention relates to a battery pack case, a method of manufacturing the battery pack case, a battery pack including the battery pack case, and a method of manufacturing the battery pack, and more particularly, to a battery pack case formed by injection, in which a flow mark is removed by a punching machine.

2. Description of the Related Art

In general, mobile electronic devices, such as portable phones, notebooks, etc., utilize not only a commonly utilized AC power source of 110V/220V supplied from an external power source, but also a secondary battery to be charged and discharged as an operation power source, so that the mobile electronic devices can be easily utilized when no external power source is available.

The secondary batteries include nickel-cadmium batteries, nickel-zinc batteries, and lithium secondary batteries. Specifically, lithium secondary batteries are widely utilized in various fields because they are small and have high capacity, high operation voltage, and high energy density per unit weight.

A lithium secondary battery is formed by connecting a bare cell (which includes an electrode assembly including a positive electrode plate, a negative electrode plate and a separator; a can for receiving the electrode assembly; and a can assembly sealing a top opening of the can) to a protective circuit module, which is formed of a positive temperature coefficient (PTC) thermistor, a thermal fuse, and a protective circuit element; and by forming a hard pack which is received in a separate outer case, or an inner pack in which a gap between the bare cell and the protective circuit module is filled with hot-melt resin and which is tubed and labeled with a thin external material or case, so that the bare cell and protective circuit module can be combined as a set for use.

A conventional battery pack case is formed by filling a metal mold with the resin of high-temperature and high-pressure. However, the conventional battery pack case has a problem in that a flow mark is formed on the surface of the battery pack case corresponding to a region close to a gate which is formed in the metal mold and through which the resin is inserted.

Since the pressure of the resin is excessively concentrated in the region close to the gate when the case is formed in the metal mold, the flow trace of the resin is indicated on the surface of the case.

This flow mark causes a flaw in the appearance of the battery pack case, so that a label does not adhere well. Moreover, since the battery pack case with the flow mark is flawed, finish work of cutting and polishing the flow mark is needed. Consequently, it takes a longer time to remove the flow mark, and the yield of production decreases.

### SUMMARY OF THE INVENTION

An aspect of an embodiment of the present invention is directed toward a battery pack case formed by injection molding, which is capable of shortening a time for removing a flow mark formed in the battery pack case, improving productivity, and preventing (or protecting) a label from getting loose when the label is attached.

An embodiment of the present invention provides a battery pack case which is formed by injection molding, the battery pack case including: a surface having a hole for removing a flow mark on the surface of the battery pack case corresponding to a gate region of a metal mold, wherein the flow mark is removed by the hole.

Another embodiment of the present invention provides a method of manufacturing a battery pack case, the method including: preparing a metal mold having a space into which a resin material is injected, and a gate as an inlet through which the resin material flows into the space; injecting the resin material in a melted state into the space within the metal mold through the gate; cooling and solidifying the resin material injected within the metal mold; separating the metal mold from the battery pack case formed in the metal mold; and forming a hole to remove a flow mark formed on the battery pack case utilizing a punching machine.

Another embodiment of the present invention provides a battery pack including: a bare cell; a protective circuit board at one side of the bare cell; first and second electrode leads for connecting the bare cell to the protective circuit board; an outer case positioned at a side of the bare cell, the outer case having a hole for removing an injection molding flow mark; and a label for packaging the outer case.

Another embodiment of the present invention provides a method of manufacturing a battery pack, the method including: forming a bare cell and a protective circuit board; electrically coupling the bare cell to the protective circuit board; forming an outer case comprising a hole generated by a punching machine to remove a flow mark formed on a side of the outer case; connecting the outer case to the bare cell; and covering the hole by packaging the outer case with a label.

In accordance with embodiments of the present invention(s) described above, the battery pack case formed by injection molding shortens the time for removing the flow mark as compared to a conventional battery pack case, improves productivity and prevents (or protects) the label from getting loose when the label is attached.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective schematic view of a bare cell included in a battery pack according to an embodiment of the present invention;

FIG. 2 is an exploded perspective schematic view illustrating a battery pack according to an embodiment of the present invention;

FIG. 3A is a sectional schematic view of a metal mold for injecting an outer case included in the battery pack according to an embodiment of the present invention;

FIG. 3B schematically illustrates the outer case which is formed in the metal mold of FIG. 3A by injection molding and on which a flow mark occurs; and

FIG. 3C schematically illustrates holes which are formed by removing the flow mark from the outer case of FIG. 3B.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

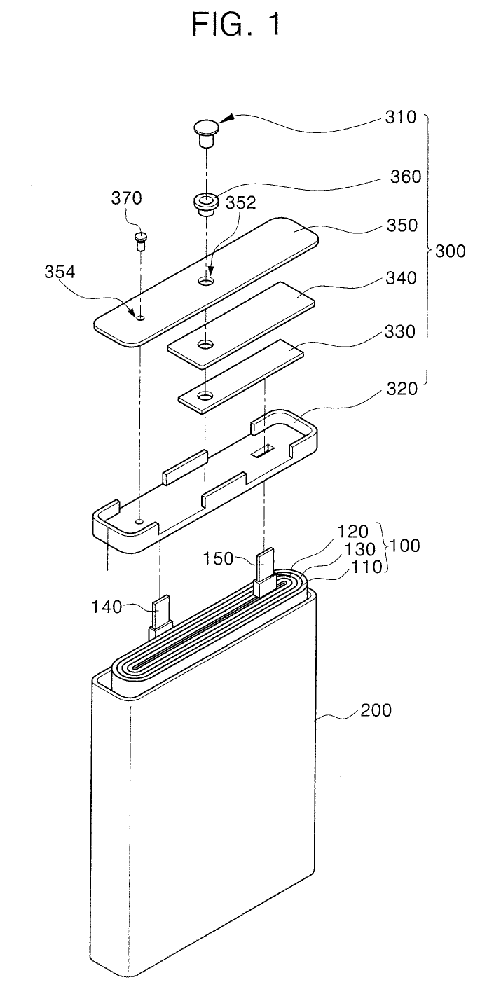

FIG. 1 is an exploded perspective schematic view of a bare cell included in a battery pack according to an embodiment of the present invention. In this embodiment, the bare cell has a prismatic (or parallelpiped) shape. However, the bare cell is not limited to the prismatic (or parallelpiped) shape, and it may be a cylindrical shape or a pouch shape.

Referring to FIG. 1, the bare cell includes: an electrode assembly 100; a can 200 with a top opening for receiving the electrode assembly 100 and an electrolyte; and a can assembly 300 electrically coupled to the electrode assembly 100 and for sealing the can 200.

The electrode assembly 100 is formed by stacking and/or winding a positive electrode plate 110 formed by coating a positive electrode collector with a positive electrode active material, a negative electrode plate 120 formed by coating a negative electrode collector with a negative electrode active material, and a separator 130 interposed between the positive electrode plate 110 and the negative electrode plate 120, for preventing (or protecting from) a short circuit of these two plates 110 and 120 and enabling movement of ions of the electrolyte.

A non-coating portion which is not coated with the positive/negative electrode active material is formed at one side of each of the positive electrode plate 110 and the negative electrode plate 120. A positive electrode tab 140 is connected to the non-coating portion formed at the positive electrode plate 110, and a negative electrode tab 150 is connected to the non-coating portion formed at the negative electrode plate 120.

In FIG. 1, the positive electrode tab 140 and the negative electrode tab 150 protrude upward above the can 200. However, any one of the positive electrode tab 140 and/or the negative electrode tab 150 may also protrude downward below the can 200 so as to be electrically coupled to the can 200.

The can 200 with the top opening may be formed of a metal material. As the metal material, in one embodiment, light and flexible aluminum, stainless steel or the like may be used to enable the can 200 to operate as a terminal when the can 200 contacts the positive electrode tab 140 or the negative electrode tab 150.

The can assembly 300, to be connected to the opened top of the can 200, includes an electrode terminal 310, an insulating case 320, a terminal plate 330, an insulating plate 340, a cap plate 350, an insulating gasket 360, and a stopper 370 of an electrolyte injection hole 354.

The cap plate 350 is a metal plate having size and shape corresponding to the top opening of the can 200. A terminal through-hole 352 in a certain size (e.g., a predetermined size) and an electrolyte injection hole 354 are formed in the cap plate 350. A safety belt may be further formed in the cap plate 350.

The electrolyte injection hole 354 is for injecting the electrolyte to smoothly move lithium ions into the can 200 for receiving the electrode assembly 100. After the can 200 is sealed by the can assembly 300, the electrolyte is injected through the electrolyte injection hole 354, and the electrolyte injection hole 354 is sealed by the stopper 370, thereby sealing the can 200.

The terminal through-hole 352 is for inserting the electrode terminal 310. The electrode terminal 310 is electrically connected to the cap plate 330 through the terminal through-hole 352, and the insulating gasket 360 formed of rubber of high insulating properties or non-conductive materials is positioned between the electrode terminal 310 and the cap plate 350 in order to insulate the electrode terminal 310 from the cap plate 350.

The insulating plate 340 and the terminal plate 330 are sequentially positioned under the cap plate 350. The terminal plate 330 is electrically connected to the negative electrode tab 150 of the electrode assembly 100 so that the electrode terminal 310 and the negative electrode tab 150 are electrically coupled to each other.

The insulating plate 340 electrically isolates the terminal plate 330 from the cap plate 350. Thus, even though the cap plate 350 is electrically connected to the positive electrode tab 140 of the electrode assembly 100, it prevents (or protects from) a short circuit.

The insulating case 320 is positioned on the top opening of the can 200, to fix the positive electrode tab 140 and the negative electrode tab 150 of the electrode assembly 100. The insulating case 320 may be formed of insulating polymer resin, such as polypropylene (PP), polyphenylene sulfide (PPS), polyester sulfone (PES) or modified-polyphenylene oxide (PPO).

A support may be formed at an edge part of the insulating case 320, to provide a space for holding the terminal plate 330 and the insulating plate 340.

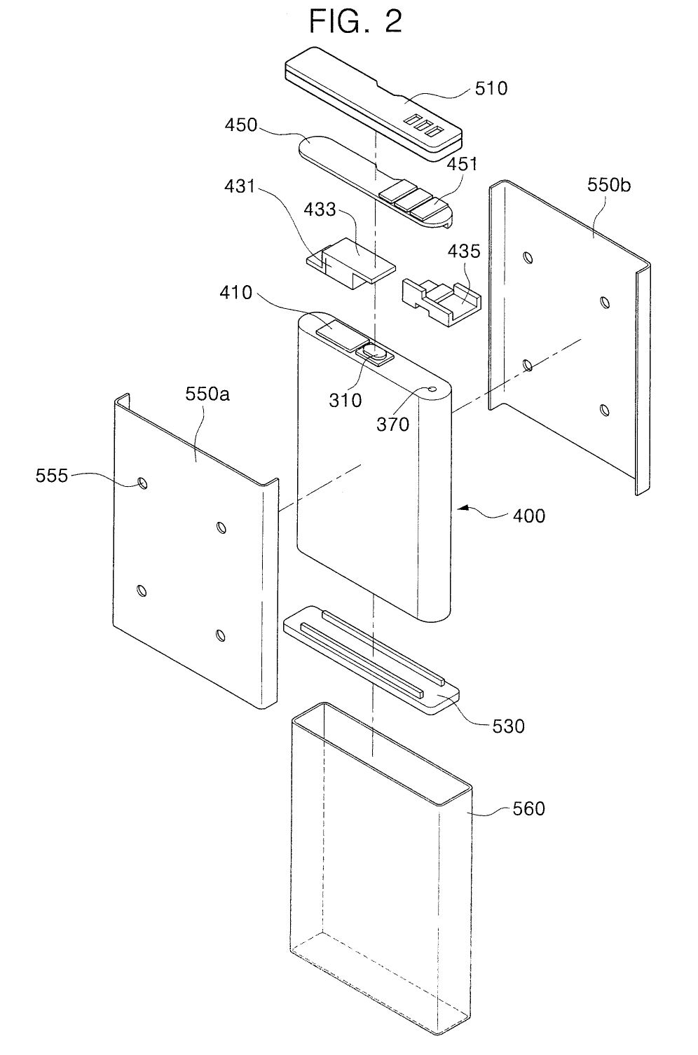

FIG. 2 illustrates a battery pack, according to an embodiment of the present invention.

Referring to FIG. 2, the battery pack includes a bare cell 400; a protective circuit board 450; and a battery pack case, wherein the battery pack case includes an upper case 510, a lower case 530 and outer cases 550a, 550b.

The bare cell 400 is formed by connecting the can 200 for receiving the electrode assembly 100 to the can assembly 300, similarly as described with reference to FIG. 1. The electrode terminal 310 and the stopper 370 of the electrolyte injection hole protrude outward on the top of the bare cell 400. The bare cell may have a cylindrical shape or a pouch shape, in addition to a prismatic shape.

The protective circuit board 450 included at one side of the bare cell 400 is electrically coupled to the bare cell 400. The protective circuit board 450 generally has a structure in which various suitable protective circuits and thermistors are positioned on a printed circuit board (PCB). Further, a number of suitable external terminals 451, which are exposed outward to be connected to external devices using the battery pack, are formed on the protective circuit board 450.

The thermistor is a device in which resistance changes depending on temperature. The thermistor may be a positive characteristic thermistor (positive temperature coefficient: PTC) in which resistance increases as temperature increases or a negative characteristic thermistor (negative temperature coefficient: NTC) in which resistance decreases as temperature increases.

A positive thermistor 431 is positioned at a high current path between the bare cell 400 and the protective circuit board 450. When an over current flows due to a short circuit or overheating, resistance increases so as to decrease current flow, thereby protecting the bare cell 400 and the battery pack from overheating and over current.

The protective circuit board 450 is electrically coupled to the bare cell 400 by first and second electrode leads 433 and 435. That is, the first and second electrode leads 433 and 435 may be coupled to the electrode terminal 310 of the bare cell 400, the cap plate 350 forming the upper region of the bare cell 400, and the stopper 370 of the electrolyte injection hole, respectively. The first electrode lead 433 may be formed of an aluminum (Al) material, and the second electrode lead 435 may be formed of a nickel (Ni) material, but the present invention is not limited to the materials described above.

Further, the method of connecting the bare cell 400 to the protective circuit board 450 is not limited to the present embodiment, and it may be changed and modified in various embodiments.

Further, in an embodiment of the present invention, an insulating member 410 is positioned on the bare cell 400, so that, when the first electrode lead 433 is connected to the bare cell 400, the bare cell 400 is prevented (or protected) from directly contacting the first electrode lead 433 and no short circuit occurs.

The battery pack case according to an embodiment of the present invention may include the upper case 510, the lower case 530 and the outer cases 550a, 550b. However, the outer cases 550a, 550b may be formed as to cover the bottom of the bare cell 400, so that the lower case 530 may not be needed.

The upper case 510 may be formed in an integral type, a buried type or a cover type. The upper case 510 may be formed in the integral type by connecting the protective circuit board 450 on the top of the battery pack and by injection molding a nylon-based synthetic resin material at low temperature and low pressure outward of the protective circuit board 450 of the battery pack.

Further, the upper case 510 may be formed in the buried type by burying the protective circuit board 450 in synthetic resin to form a buried upper case 510 of the protective circuit board 450 and then by connecting the protective circuit board 450 to the top of the battery pack while the protective circuit board 450 is buried in the buried upper case 510 of the protective circuit board 450.

Further, the upper case 510 may be made in the cover type by connecting the protective circuit board 450 to the top of the battery pack and the upper case 510 which is pre-formed of synthetic resin to the battery pack to which the protective circuit board 450 is coupled.

That is, the upper case 510 may be formed by various methods, and the present invention does not limit the method of forming the upper case 510.

The outer cases 550a, 550b may be formed in the manner that a first outer case 550a and a second outer case 550b are separated from each other to cover the side of the bare cell 400. Here, the outer cases 550a, 550b may be formed of metal materials or plastic resin.

When the outer case 550a, 550b is formed of plastic resin, it can be formed to be lighter and thinner, compared to that formed of a metal material.

Further, the outer case 550a, 550b may be formed in a rounded shape so that corner portion have curves. Accordingly, when the battery pack including the bare cell 400 is mounted in an electronic device, contact area is reduced to reduce the friction between the battery pack and the electronic device.

Further, the outer case 550a, 550b may be formed in a shape for receiving the bare cell 400, by integrally forming the first outer case 550a and the second outer case 550b (e.g., as one body). As such, the present invention does not limit the shape or structure of the outer case 550a, 550b.

When the upper case 510, the lower case 530, and the outer cases 550a, 550b are coupled together after the bare cell 400 is connected to the protective circuit board 450 as described above, the battery pack is completed by packing a label to increase a binding force of the bare cell 400 and the outer case 550a, 550b and to protect from external impact.

One or more holes 555 may be formed in the first outer case 550a and/or the second outer case 550b. When the outer case 550a, 550b is formed by injection, a flow mark is formed on the surface of the outer case corresponding to a region close to a gate formed in the metal mold. Then, the holes 555 are formed by removing the flow mark with a punching machine.

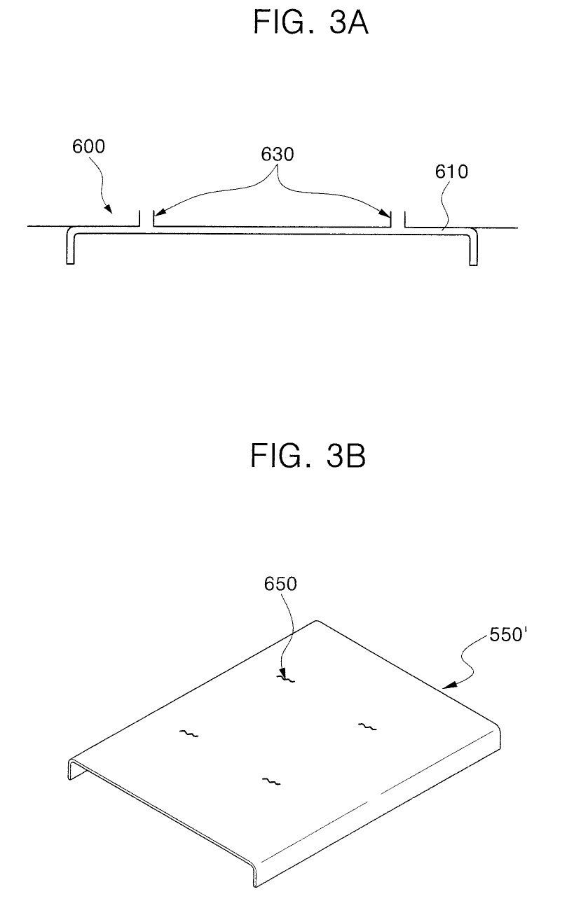

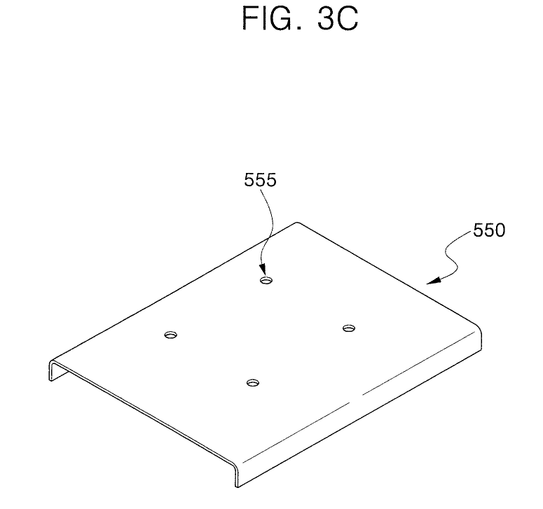

FIG. 3A is a sectional schematic view of a metal mold 600 for injecting the outer case included in the battery pack, according to an embodiment of the present invention; FIG. 3B schematically illustrates the outer case with flow marks that occur when the outer case is formed by injection in the metal mold 600 of FIG. 3A; and FIG. 3C illustrates holes formed when the flow marks are removed from the outer case of FIG. 3B.

Referring to FIGS. 3A, 3B and 3C, the metal mold 600 is a cast which is formed of metal and has a desired case shape to be formed. The metal mold 600 has a space 610 into which resin materials are injected, and one or more gates 630 as inlets through which resin materials flow into the space 610.

The case is formed by injecting the resin materials, which are heated to be melted, into the space 610 of the metal mold through the gates 630 by utilizing hydraulic pressure (e.g., an electric motor), and then by removing the metal mold when the resin materials are cooled and solidified.

In the case 550′ formed by the aforementioned method, the pressure of the resin is excessively concentrated on the surface of the case 550′ corresponding to a region close to the gates, as illustrated in FIG. 3B, thereby forming, on the surface of the case 550′, flow marks 650 which are flow traces of resin which is the molding material.

In a conventional technique, since finish work should be performed to cut and polish the flow marks, it took a long time to remove the flow marks and the yield of production was decreased. Since the work process itself is elaborate and precise, it causes a problem in the process.

However, like the case illustrated in FIG. 3C and formed according to an embodiment of the present invention, when the portions with the flow marks are removed by using a punching machine, the time for removing the flow marks is shortened compared to the conventional technique, thereby improving productivity.

Subsequently, since holes 555 formed on the places where the flow marks are removed are wrapped by packaging a label, a defect in the appearance is prevented or reduced and the label adheres better, unlike the conventional technique in which the label does not adhere well due to the flow marks.

The holes 555, which are formed by the punching machine to remove the flow marks 650, may be less or more or may be formed in the same number of the gates formed in the metal mold.

Further, the hole 555 may be in a round shape as illustrated in an embodiment of the present invention, but it may be modified and changed in various suitable shapes to achieve the purpose for removing the flow marks 650.

Further, the position at which the hole 555 is formed is the position at which the flow mark 650 is formed. In one embodiment, the size of the hole 555 may be similar to or bigger than the flow mark, so that the flow mark 650 is completely removed.

The aforementioned method is not limited to the outer case illustrated in the embodiment of the present invention. The method may be applied to a case which is formed by injection molding and in which the flow mark is formed on the surface thereof, irrespective of the shape of hard pack received in a separate outer case or the shape of an inner pack in which the gap between the bare cell and the protective circuit module is filled with hot melt resin and which is tubed or labeled with a thin external material or case.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack case which is formed by injection molding, the battery pack case comprising: a surface having a hole for removing a flow mark on the surface of the battery pack case corresponding to a gate region of a metal mold, wherein the flow mark is removed by the hole.

2. The battery pack case according to claim 1, wherein the battery pack case is in a hard pack or a case included in an inner pack.

3. The battery pack case according to claim 1, wherein the hole comprises a number of holes in the same number as that of gates of the metal mold.

4. The battery pack case according to claim 3, wherein the hole is at a position in which the flow mark is formed.

5. The battery pack case according to claim 4, wherein the hole is not less than the flow mark in size.

6. A method of manufacturing a battery pack case, the method comprising:
preparing a metal mold having a space into which a resin material is injected, and a gate as an inlet through which the resin material flows into the space;
injecting the resin material in a melted state into the space within the metal mold through the gate;
cooling and solidifying the resin material injected within the metal mold;
separating the metal mold from the battery pack case formed in the metal mold; and
forming a hole to remove a flow mark formed on the battery pack case utilizing a punching machine.

7. The method according to claim 6, wherein the gate includes a number of gates, and wherein the hole includes a number of holes in the same number as that of the gates included in the metal mold.

8. The method according to claim 7, wherein the hole is not less than the flow mark in size.

9. A battery pack comprising:
a bare cell;
a protective circuit board at one side of the bare cell;
first and second electrode leads for connecting the bare cell to the protective circuit board;
an outer case positioned at a side of the bare cell, the outer case having a hole for removing an injection molding flow mark; and
a label for packaging the outer case.

10. The battery pack according to claim 9, further comprising: an upper case and a lower case.

11. The battery pack according to claim 10, wherein the upper case is an integral type upper case, a buried type upper case, or a cover type upper case.

12. The battery pack according to claim 9, wherein the battery pack has a hard pack shape or an inner pack shape.

13. The battery pack according to claim 9, wherein the bare cell has a prismatic shape, a cylindrical shape or a pouch shape.

14. The battery pack according to claim 9, wherein the outer case comprises a first outer case and a second outer case.

15. The battery pack according to claim 9, where the flow mark comprises a number of flow marks, and wherein the hole comprises a number of holes in the same number as that of the number of flow marks.

16. The battery pack according to claim 15, wherein the hole is at a position corresponding to the flow mark to remove the flow mark.

17. The battery pack according to claim 16, wherein the hole is not less than the flow mark in size.

18. A method of manufacturing a battery pack, the method comprising:
forming a bare cell and a protective circuit board;
electrically coupling the bare cell to the protective circuit board;
forming an outer case comprising a hole generated by a punching machine to remove a flow mark formed on a side of the outer case;
connecting the outer case to the bare cell; and
covering the hole by packaging the outer case with a label.

19. The method according to claim 18, wherein the forming of the outer case comprises:
preparing a metal mold having a space into which a resin material is injected, and a gate as an inlet through which the resin material flows into the space;
injecting the resin material in a melted state into the metal mold through the gate;
cooling and solidifying the resin material injected into the metal mold;
separating the metal mold from the battery pack case formed in the metal mold; and
forming the hole to remove the flow mark formed on the battery pack case by utilizing a punching machine.

20. The method according to claim 19, wherein the gate includes a number of gates, and wherein the hole includes a number of holes in the same number as that of the gates included in the metal mold.

21. The method according to claim 20, wherein the hole is not less than the flow mark in size.

22. The method according to claim 18, further comprising forming an upper case with the protective circuit board.

23. The method according to claim 22, wherein the upper case is an integral type upper case, a buried type upper case, or a cover type upper case.
